(19) United States
(12) Patent Application Publication
(10) Pub. No.: US 2025/0051938 A1
(43) Pub. Date: Feb. 13, 2025

(54) SOLID OXIDE ELECTROLYSIS CELL CORE PLANT

(71) Applicant: Topsoe A/S, Kgs. Lyngby (DK)

(72) Inventors: Michael Boe, Klampenborg (DK); Klaus Risbjerg Jarlkov, Køge (DK); Anders Helbo Hansen, Espergærde (DK); Kristian Bjarklev, Kgs. Lyngby (DK)

(73) Assignee: Topsoe A/S, Kgs. Lyngby (DK)

(21) Appl. No.: 18/719,586

(22) PCT Filed: Nov. 25, 2022
(86) PCT No.: PCT/EP2022/083336

§ 371 Date: Jun. 13, 2024

(30) Foreign Application Priority Data
Dec. 23, 2021 (EP) 21217287.8

(51) Int. Cl. C25B 9/70; C25B 9/67; C25B 15/021

(52) U.S. Cl. CPC C25B 9/70; C25B 9/67; C25B 15/021

(57) ABSTRACT

An SOEC core plant, comprising a plurality of SOEC stacks assembled in a plurality of SOEC cores, wherein each of the SOEC cores may be individually isolated and controlled independently from the other SOEC cores of the plant.

### FIELD OF THE INVENTION

The invention relates to a Solid Oxide Electrolysis Cell (SOEC) core plant, comprising a plurality of SOEC stacks assembled in a plurality of SOEC cores, wherein each of the SOEC cores may be individually isolated and controlled independently from the other SOEC cores of the plant.

### BACKGROUND OF THE INVENTION

In SOEC stacks which have an operating temperature between 600° C. and 1000° C., preferably between 600° C. and 850° C., several cell units are assembled to form the stack and are linked together by interconnects. Interconnects serve as a gas barrier to separate the anode and cathode sides of adjacent cell units, and at the same time they enable current conduction between the adjacent cells, i.e. between an anode of one cell and a cathode of a neighbouring cell. Further, interconnects are normally provided with a plurality of flow paths for the passage of process gas on both sides of the interconnect. To optimize the performance of a SOEC stack, a range of positive values should be maximized without unacceptable consequence on another range of related negative values which should be minimized. Some of these values are:

| VALUES TO BE MAXIMIZED | VALUES TO BE MINIMIZED |
|---|---|
| Process gas utilization | Cost |
| Electrical efficiency | Dimensions |
| Lifetime | Production time |
| | Fail rate |
| | Number of components |
| | Material use |
| | Parasitic loss (heating, |
| | cooling, blowers . . . ) |

Almost all the above listed values are interrelated, which means that altering one value will impact other values. Some relations between the characteristics of process gas flow in the cells and the above values are mentioned here:

### Process Gas Utilization:

The flow paths on the interconnect should be designed to seek an equal amount of process gas to each cell in a stack, i.e. there should be no flow- “short-cuts” through the stack.

### Parasitic Loss:

Design of the process gas flow paths in the SOEC stack and its cell units should seek to achieve a low pressure loss per flow volume, which will reduce the parasitic loss to blowers.

### Electric Efficiency:

The interconnect leads current between the anode and the cathode layer of neighbouring cells. Hence, to reduce internal resistance, the electrically conducting contact points (hereafter merely called “contact points”) of the interconnect should be designed to establish good electrical contact to the electrodes (anode and cathode) and the contact points should no where be far apart, which would force the current to run through a longer distance of the electrode with resulting higher internal resistance.

### Lifetime:

It is desirable that the lifetime of an SOEC stack is maximized, i.e. that in SOEC mode the amount of electrolysis product (e.g. H₂ and/or CO) is maximized. Stack lifetime depends on a number of factors, including the choice of the interconnect and spacer, on flow distribution on both process gas sides of the interconnect, evenly distributed protective coating on the materials, on the operating conditions (temperature, current density, voltage, etc), on cell design and materials and many other factors.

### Cost:

The cost of the SOEC stack can be reduced by not using noble materials, by reducing the production time of the stack components, minimizing the number of components and by minimizing the material loss (the amount of material discarded during the production process).

### Dimensions:

The overall dimensions of a cell stack are reduced, when the interconnect design ensures a high utilization of the active cell area. Dead-areas with low process gas flow should be reduced and inactive zones for sealing surfaces should be minimized.

### Production Time.

Production time of the stack components should be minimized, and the design of the stack and its components should also contribute to a fast assembling of the stack. In general, for every component the stack design renders unnecessary, there is a gain in production time.

### Fail Rate.

The stack components production methods and materials should permit a low fail rate (such as unwanted holes in the interconnect gas barrier, uneven material thickness or characteristics). Further the fail-rate of the assembled cell stack can be reduced when the interconnect design reduces the total number of components to be assembled and reduces the length and number of seal surfaces.

### Number of Components.

Apart from minimizing errors and assembling time as already mentioned, a reduction of the number of components leads to a reduced cost.

The way the anode and cathode gas flows are distributed in a SOEC stack is by having a common manifold for each of the two process gasses, the oxy and fuel gas. The manifolds can either be internal or external. The manifolds supply process gasses to the individual layers in the SOEC stack by the means of channels to each layer. The channels are normally situated in one layer of the repeating elements which are comprised in the SOEC stack, i.e. in the spacers or in the interconnect. Internal gas manifolds are often in the form of apertures in the cell and/or interconnect components which form one or a number of channels and gas in-/outlets when the cell components are stacked. External manifolds on the other hand are often formed as covers which may cover for instance one or more sides of the SOEC stack and thereby distribute the process gas to the side of the stack and thus the edge of each cell in the stack. Instead of a cover the stack may also simply be arranged in a container where the process gas flows and thus the process gas has access to the sides of the stack from where the process gas may flow into the stack from the open edge zones of each cell.

High temperature electrolysis (SOEC) is an endothermic electrochemical conversion of H2O to H2 or CO2 to CO on the fuel side of the cell. The endothermic electrochemical process is counteracted by the heat generated inside the SOEC stack from ohmic losses (Joule heating), which is proportional with the current through the stack. When the endothermic process is balanced with the ohmic losses, the stack can be operated “thermoneutrally”, i.e. the temperature profile from fuel inlet to outlet is ideally constant. But in many operating points, especially at part load, the heat generated by the ohmic losses is less than the heat consumed for the electrochemical process—this creates a thermal profile across the cells, where the temperature drops from inlet to outlet.

The local current density (i) in a given area of the cell is controlled by the Nernst potential, which is affected by the local temperature and gas compositions. The local gas composition is controlled by stack design, e.g. the choice of flow paths, where the goal is to get as even distribution of gas across the cell, between the cells in a stack and between stacks—all while simultaneously minimizing the pressure drop. But even with perfect flow distribution, the fuel concentration will always be higher at fuel inlet (and product concentration low), which favors a higher than average current density. When the stack is run at an operating point (current) below the thermoneutral point, the temperature at fuel inlet is higher than the rest of the cell—further increasing the local current density. Thus, in most operating points, the maximum current density (imax) is located at the fuel inlet area.

Several degradation mechanisms are highly affected by the current density, and even accelerated if the current density is higher than a certain “threshold value”. For example, Chen et al. (Journal of The Electrochemical Society, 160 (8) F883-F891 (2013)) demonstrate that additional degradation mechanisms, such as the formation of ZrO2 nanoparticles, can be observed in SOECs operated at high current densities (at 1 A/cm2 or 1.5 A/cm2 in electrolysis mode), while the same degradation mechanisms were not present in tests running at 0.75 A/cm2 or 0.5 A/cm2 in electrolysis mode. In another example (Knibbe et al, Journal of The Electrochemical Society, 157 (8) B1209-B1217 (2010)), increased degradation of ohmic resistance was observed due to oxygen bubble formation and delamination at the oxygen electrode/electrolyte interface, when the electrolysis current was increased from 1 A/cm2 to 1.5 A/cm2 to 2 A/cm2. Mogensen et al have reported that operation at high current densities (high electrode overpotentials) can lead to the loss of Ni from the electrochemically active fuel electrode/electrolyte interface in SOECs based on Ni/YSZ electrodes (Fuel Cells, 17, 2017, No. 4, 434-441). In SOFC mode, Hagen et al. (Journal of The Electrochemical Society, 153 (6) A1165-A1171 (2006)) have demonstrated that the degradation rate increased as a function of cell polarization (current density) at all operating temperatures tested (750° C., 850° C. and 950° C.). The degradation rate at a fixed current density increased more steeply at 750° C. than at 850° C. (and 950° C.), suggesting that the degradation phenomena is related to electrode overpotential.

Keeping the maximum current density (imax) as low as possible, while maintaining high production rate (iavg) is thus highly desirable to minimize stack degradation and loss of system efficiency. In other words, it is desirable to obtain even current density profile across the stack, and especially a low imax while maintaining a fixed iavg.

As production rate from a stack is linked to the active area (the area where the electrochemical processes occur), it is desirable to maximize the active area. The active area of a stack is naturally linked to the size of the cells, but the active area of the cell is reduced by sealing area and area used for manifolding. It is thus desirable to maximize the active area of the cell, by reducing the area used for sealing and manifolding.

In SOEC mode, the product is the converted gas—and the quality of the converted gas, also called the product gas is critical for downstream applications. It is thus desirable to minimize leaks of undesired components (e.g. air) into the product to obtain a high purity.

The individual SOEC stacks, in which the electrolysis take place, are limited in physical size and consequently so is the amount of gas they can convert. This means that for industrial size solid oxide electrolyzers, a large number of stacks are used, possibly in the thousands. All the stacks need to be replaced with new stacks at regular intervals, and furthermore individual stacks may develop a fault prematurely and need unexpected replacement. It is a time-consuming process to replace stacks. Valuable production time is also lost cooling the stacks down prior to replacement, and after replacement to heat up the new stacks. Regular stack replacement and unexpected replacement of stacks significantly reduce plant uptime, which significantly reduces the valuableness of the electrolyzer plant.

US2021098796 discloses a modular pressurized hotbox for use and substitution in a variety of pressurized electrochemical applications to include reversible solid oxide electrolyzer and fuel cells, energy storage systems, renewable fuel production, solid-state hydrogen pumping and liquefaction, and oxygen transport membranes. This is enabled by mixed electronic and ionic conducting compositions of vanadia-yttria and vanadia-calcia stabilized zirconia and a dry powder method of manufacture for ceramic core stacks.

US2021156039 describes a modular system for hydrogen generation includes a plurality of cores and a hub. Each core includes an electrolyzer and a power supply. The power supply is operable to manage electrical power to the electrolyzer of the core and is redundant to the power supply of at least another one of the plurality of cores. The hub includes a water module, a heat exchange module, and a switchgear module. The water module includes a water source in fluid communication with the electrolyzer of each one of the plurality of cores, the heat exchange module includes a heat exchanger in thermal communication with the electrolyzer of each one of the plurality of cores, and the switchgear module includes a switch activatable to electrically isolate the power supply of each one of the plurality of cores.

WO15169940 discloses a core unit in the shape of an integrated module for fuel cell based power generation consists of an inlet or more inlets for fuel cell suitable fuels, said fuels comprising hydrogen, hydrocarbon-based fuels, steam reformed fuels (such as hydrocarbons, alcohols and ethers) and ammonia, one or more inlets for air, one or more off-gas outlets, heat exchangers, and a fuel cell assembly, all mounted in an insulated housing or in several separate insulated housings connected by relevant piping. The unit is an SOFC sub-system, preferably in the 1.5 kW (DC) power range, designed to provide a simple interface to natural gas based SOFC technology. The system features tight integration of the SOFC stack(s) or stack module(s) and all hot balance of plant components. Since the system is designed for anode off-gas recycling, the unit requires no external water supply once in operation. Anode gas recycling results in high overall fuel utilization and in high electrical efficiency.

WO20165548 discloses an electrolytic cell for an electrolytic treatment of a liquid, the electrolytic cell comprising a receptacle defining an electrolysis chamber; a first set of conductive plates, a second set of conductive plates, and a third set of conductive plates, which are arranged in the electrolysis chamber, the conductive plates of the first, second and third sets extending radially in relation to the longitudinal axis of the receptacle; an electrical power source configured to supply electricity to the conductive plates of the first, second and third sets; a switching device configured to interrupt the electricity supply to the conductive plates of the first, second and third sets and to modify the electrical connection between the conductive plates of the first, second and third sets and positive and negative terminals of the electrical power source; and a control unit configured to control the switching device according to an operating cycle.

None of the above described known art documents provides a solution to the above described problems which are solved by the present invention.

Therefore, with reference to the above listed considerations, there is a need for an SOEC core plant, comprising a plurality of SOEC cores each comprising a plurality of SOEC stacks, wherein each of the SOEC cores is adapted to be individually isolated, controlled and adapted to operate independently from the other of the plurality of SOEC cores to effectively solve the above described problems.

These and other objects are achieved by the invention as described below.

### SUMMARY OF THE INVENTION

The invention is a Solid Oxide Electrolysis Cell (SOEC) plant, comprising a plurality of SOEC cores, each SOEC core comprising a plurality of SOEC stacks. Each of the SOEC cores may be individually isolated, individually controlled and adapted to operate independently from the other of the plurality of SOEC cores in the SOEC plant. Accordingly, when an SOEC core needs service, it may be taken out of operation without shutting down the whole SOEC plant. Hence, by dividing the SOEC plant into several SOEC cores, the plant and thus the production becomes redundant.

In an embodiment, the SOEC cores each comprises an SOEC core shell with shell thermal insulation cladding at least the outside of said SOEC core shell. The core is understood as a piece of equipment with an internal volume large enough to house other pieces of equipment. The core shell may for instance be made of metal and provides a barrier to enable the core to contain fluids and a pressure difference to the outside of the core. As described, the core comprises within the SOEC core shell a plurality of SOEC stacks. The SOEC stacks may be arranged in a plurality of SOEC stack modules. The stack module is understood as an equipment which provides a fixture to hold one or more stacks.

In an embodiment, the SOEC core has an inner hot zone at least partly surrounded with hot zone thermal insulation within the SOEC core shell and a recuperating space arranged at least partly around the outside of said hot zone thermal insulation and within the SOEC core shell to separate the hot zone from the SOEC core shell and provide a recuperating fluid path for a recuperating fluid. Hence, the core comprises two portions of thermal insulation, an outer, thermally insulating the core shell; and an inner, thermally insulating the inner hot zone. Between the two portions of thermal insulation there is a recuperating space. So even if the inner hot zone thermal insulation is not completely effective, any heat loss from the hot zone can be absorbed by a recuperating fluid flowing in the recuperating space, thus minimizing the thermal stress on the core shell by the hot zone.

According to the invention as mentioned above, instead of having all SOEC stacks of a production plant enclosed in one piece of equipment, SOEC stacks are divided into portions, each portion being contained in a separate piece of equipment called a core. Each core can be isolated with regard to the process from the rest of the cores in a production plant, by closing shut off valves on process inlet side, process outlet side, oxy inlet side and oxy outlet side. Shut off valves on process and oxy inlet sides may be placed before heat exchanger of the core, because the temperatures here are low. Shut off valves on process and oxy outlet sides may be placed after heat exchanger because the temperatures here are low. The lower temperatures at valve locations significantly reduces valve cost and increases reliability of valve function. A core shut off from the rest of the process, the rest of the cores of a production plant, can have SOEC stacks replaced or otherwise serviced, while the remaining cores in a production plant may continue electrolysis production instead of shutting down the entire plant. A problem arising from dividing a production plant into cores is an increased heat loss from the hot electrolysis process, which is the result from the created much larger surface through which heat loss can happen when the SOEC stacks are placed in many smaller cores compared to packing all stacks into one volume only. The heat loss problem can be offset by applying a core design as mentioned in the above comprising thermal insulation, hot zone and recuperation space, thereby recuperating the thermal energy lost from hot zone through the hot zone thermal insulation. The shell core design is advantageous in high inlet gas pressure operation, because the pressure bearing shell is kept cool at the inlet temperature before heating the process gas in heat exchanger and heater. Further in high pressure applications it is advantageous to have smaller units to keep wall thicknesses down, and thus the utilization of many smaller cores is favored to a single larger vessel holding all SOEC stacks.

In an embodiment of the invention, the SOEC plant comprises 10 or more SOEC cores. Hence, when shutting down an SOEC core for instance for service such as replacement of SOEC stacks, the production of the whole SOEC plant only drops by 10% or less.

In an embodiment of the invention, the SOEC plant comprises 25 or more SOEC cores. Accordingly, only a production drop of 4% or less is a result of shutting down a single SOEC core.

In a further embodiment, the SOEC plant comprises 100 or more SOEC cores, with the resulting even less drop in production as a consequence of shutting down a single SOEC core for service.

In an embodiment of the invention, the hot zone is located in the centre, around the centre axis of the core shell. This may be advantageous in view of the above discussed thermal losses, since a central location of the hot zone provides a minimum of heat loss and provides the possibility of an even thickness of thermal insulation and recuperating space around the hot zone, which may also be the most effective way to minimize heat loss.

In a further embodiment of the invention, the SOEC core shell has at least a first shell section comprising a first end of the SOEC core shell and a second shell section comprising a second end of the SOEC core shell, said shell sections are assembled by a flange connection, one flange is arranged on the first shell section and another flange is arranged on the second shell section and the flange connection is located near the first end of the SOEC core shell. Hence, the SOEC core shell may be in a two-part form, where the two parts may be fluid and pressure tight assembled via a flange connection. This allows for easy disassembly of the SOEC core shell to service and maintenance of the equipment within the SOEC core shell. Ever more easy access to the internals of the SOEC core shell is ensured since the flange connection is located near the first end of the SOEC core shell, which means that when the second shell section is removed, most of the internals are revealed and accessible for service.

In an embodiment of the invention, the SOEC core further comprises one or more heat exchangers, one or more heaters, a plurality of fluid connections, and a plurality of electrical connections to the plurality of SOEC stack modules. This is all equipment known in the art to enable the process of the SOEC stacks, as they need process gas at suitable temperatures and electrical current. But moreover, said one or more heat exchangers, one or more heaters, plurality of fluid connections, plurality of electrical connections and the plurality SOEC stack modules are fixed to the first shell section. This provides all the relevant equipment to still be securely fixed to the first shell section for access and service when the second shell section is removed by disconnecting the flange connection as discussed in the above.

In a further embodiment of the invention, said one or more heat exchangers and one or more heaters are located within said hot zone. This has the advantage, that this hot equipment is insulated by the hot zone thermal insulation and that any heat lost from this hot equipment is recuperated by the recuperating fluid flowing in the recuperating space as discussed in the above. In a further embodiment, at least a larger part of said plurality of electrical connections are located outside said hot zone, to ensure that they are kept relatively cold.

In an embodiment of the invention, the SOEC core further comprises a plurality of lead-through holes for said plurality of fluid connections, and plurality of electrical connections, wherein said lead-through holes are located in said first shell section. Further, the SOEC core according may comprise a plurality of shut off valves connected to one or more of said plurality of fluid connections adapted to cut off the fluid flowing in said fluid connections, wherein said plurality of shut off valves are arranged outside the SOEC core shell and thereby outside both said hot zone and said recuperating space. The location in the first shell section of the mentioned equipment again ensures that the second shell section can be removed for easy access and service as discussed in the above. Having the plurality of shut off valves arranged outside the SOEC core shell has the advantages that the function, cost and material choice for the shut off valves are optimized, since they are not located in any hot or otherwise aggressive environment. Furthermore, the location outside the SOEC core shell ensures very easy and fast access to the shut off valves, an advantage in case of malfunction of the SOEC core (or the equipment within the SOEC core). Furthermore, the SOEC core may comprise one or more circuit breakers adapted to cut off power running in said electrical connections. Also, the circuit breakers may be located outside the SOEC core. The components and materials located within the hot zone may en an embodiment be adapted to withstand temperatures up to at least 825° C. Hence, as described in the above, since the hot zone is thermal insulated and further is at least partly surrounded by a recuperating space, the components and materials located outside the hot zone need then not be adapted to operate in as high a temperature.

In an embodiment of the invention, at least one of the plurality of fluid connections mentioned, is a process fluid connection adapted to provide process fluid connection from a process fluid inlet arranged in the SOEC core shell, further to the recuperating space within the SOEC core shell and further to said plurality of SOEC stack modules. This means that the recuperating fluid flowing in the recuperating space may be a process fluid. Not only does this omit the necessity for a dedicated extra fluid to perform the recuperating, but also this may serve the purpose to pre-heat a process fluid. Thus, less energy is needed to heat up that process fluid to the necessary operating temperature, the number of necessary fluids is minimized and as mentioned before, the heat energy lost from the hot zone is recuperated and does therefor not affect the core shell or lead to excess heat loss, which would otherwise be the effect of splitting up the plant in several smaller entities (cores). The present invention therefore both enables a more service friendly and robust production plant with less down time than a “not splitted” plant but at the same time recuperates the otherwise larger heat loss and uses this energy for the SOEC process.

In an embodiment of the invention, the plurality of SOEC stack modules are arranged at least partly in a circular arrangement around a central axis of said SOEC core shell. This may be an advantageous arrangement of the SOEC stack modules regarding practicality, accessability, production and the process taking place in the SOEC stack modules.

In an embodiment of the invention, the SOEC core comprises between 2 and 50 SOEC stack modules, preferably between 3 and 20 SOEC stack modules, preferably between 5 and 9 SOEC stack modules, preferably 6 stack modules. The number of SOEC stack modules in a SOEC core may be optimized according to the total plant size, material costs, energy consumption, number of SOEC stacks pr. SOEC stack module, process fluids to name a few.

In a further embodiment, the invention comprises a method of operating a Solid Oxide Electrolysis Cell (SOEC) plant. The SOEC core may comprise any of the above mentioned embodiments. In one embodiment, the SOEC plant comprises a plurality of SOEC cores, each SOEC core comprises an SOEC core shell with shell thermal insulation cladding at least the outside of said SOEC core shell as described in the above. Further, the SOEC core comprises within the SOEC core shell a plurality of SOEC stack modules, each SOEC stack module comprises one or more SOEC stacks, wherein said SOEC core has an inner hot zone at least partly surrounded with hot zone thermal insulation within the SOEC core shell and a recuperating space arranged at least partly around the outside of said hot zone thermal insulation and within the SOEC core shell to separate the hot zone from the SOEC core shell and provide a recuperating fluid path for a recuperating fluid, as described in more detail in the above. The method comprises the steps of: Providing electrical power to said SOEC stacks, which as known in the art enables the electrolysis stack to perform electrolysis when further provided with suitable process fluids. Providing a process fluid to the SOEC core through a process fluid inlet, further through said recuperating space where it recuperates thermal energy escaping said inner hot zone, which heats up the process fluid. As described, this is feature of the invention enables the SOEC core to make use of any waste heat which escapes the hot zone even through the hot zone thermal insulation, by using it to pre-heat the process fluid; furthermore this protects the outer lying part of the core against high temperatures. As the Solid Oxide cells are high temperature cells, this thermal energy recuperation significantly improves the overall efficiency of the SOEC core, despite the splitting up of an entire production plant in such cores. In a further step of the method, the now heated process fluid is then provided to said SOEC stacks.

### FEATURES OF THE INVENTION

1. Solid Oxide Electrolysis Cell (SOEC) plant, comprising a plurality of SOEC stacks, said SOEC plant is divided into a plurality of SOEC cores, wherein each of said SOEC cores is adapted to be individually isolated, individually controlled and adapted to operate independently from the other of the plurality of SOEC cores.

2. SOEC plant according to feature 1, wherein each of said SOEC cores comprises a plurality of SOEC stack modules and each of said SOEC stack modules comprises one or more of said SOEC stacks.

3. SOEC plant according to any of the preceding features, wherein said SOEC plant comprises 10 or more SOEC cores.

4. SOEC plant according to any of the preceding features, wherein said SOEC plant comprises 25 or more SOEC cores.

5. SOEC plant according to any of the preceding features, wherein said SOEC plant comprises 100 or more SOEC cores.

6. SOEC plant according to any of the preceding features, wherein said plurality of SOEC cores each comprises an SOEC core shell with shell thermal insulation cladding at least the outside of said SOEC core shell and further comprising a plurality of shut off valves adapted to cut off one or more process fluids flowing to or from, or to and from said SOEC cores, wherein said plurality of shut off valves are arranged outside the SOEC core shell.

7. SOEC plant according to feature 6, wherein each of said SOEC cores has an inner hot zone at least partly surrounded with hot zone thermal insulation within the SOEC core shell and a recuperating space arranged at least partly around the outside of said hot zone thermal insulation and within the SOEC core shell to separate the hot zone from the SOEC core shell and provide a recuperating fluid path for a recuperating fluid.

8. SOEC plant according to feature 7, wherein said hot zone is located in the centre and around a centre axis of each of the SOEC core shells.

9. SOEC plant according to any of the preceding features 6, 7 or 8, wherein each of said SOEC core shells comprises at least a first shell section comprising a first end of the SOEC core shell and a second shell section comprising a second end of the SOEC core shell, said shell sections are assembled by a flange connection, one flange is arranged on the first shell section and another flange is arranged on the second shell section and the flange connection is located near the first end of the SOEC core shell.

10. SOEC plant according to feature 9, wherein each of said SOEC cores further comprises one or more heat exchangers, one or more heaters, a plurality of fluid connections, and a plurality of electrical connections to the plurality of SOEC stack modules and wherein said one or more heat exchangers, one or more heaters, plurality of fluid connections, plurality of electrical connections and the plurality SOEC stacks are fixed to said first shell section.

11. SOEC plant according to feature 10, wherein said one or more heat exchangers and one or more heaters are located within said hot zone.

12. SOEC plant according to features 10 or 11, wherein at least a larger part of said plurality of electrical connections are located outside said hot zone.

13. SOEC plant according to any of the preceding features 10, 11 or 12, further comprising a plurality of lead-through holes for said plurality of fluid connections, and plurality of electrical connections, wherein said lead-through holes are located in said first shell section.

14. SOEC plant according to any of the preceding features 10-13, wherein said plurality of shut off valves are connected to one or more of said plurality of fluid connections and are adapted to cut off the fluid flowing in said fluid connections.

15. SOEC plant according to any of the preceding features 10-14, further comprising a plurality of circuit breakers adapted to cut off power running in said electrical connections.

16. SOEC plant according to any of the preceding features 7-15, wherein the components and materials located within said hot zone are adapted to withstand temperatures up to 825° C.

17. SOEC plant according to any of the preceding features 7-16, wherein the components and materials located within said hot zone are adapted to withstand temperatures up to 1000° C.

18. SOEC plant according to any of the preceding features 10-17, wherein at least one of the plurality of fluid connections is a process fluid connection adapted to provide process fluid connection from a process fluid inlet arranged in each of the SOEC core shells, further to the recuperating space within the SOEC core shell and further to said plurality of SOEC stack modules.

19. SOEC plant according to any of the preceding features 6 18, wherein said plurality of SOEC stack modules are arranged at least partly in a circular arrangement around a central axis of said SOEC core shell.

20. SOEC plant according to any of the preceding features 2-19, wherein each of said SOEC cores comprises between 2 and 50 SOEC stack modules, preferably between 3 and 20 SOEC stack modules, preferably between 5 and 9 SOEC stack modules, preferably 6 stack modules.

21. Method of operating a Solid Oxide Electrolysis Cell (SOEC) plant, comprising a plurality of SOEC stacks, said SOEC plant is divided into a plurality of SOEC cores comprising an SOEC core shell, said SOEC cores has an inner hot zone at least partly surrounded with hot zone thermal insulation within the SOEC core shell and a recuperating space arranged at least partly around the outside of said hot zone thermal insulation and within the SOEC core shell to separate the hot zone from the SOEC core shell and provide a recuperating fluid path for a recuperating fluid the method comprises the steps of,
providing electrical power to said plurality of SOEC stacks,
providing a process fluid to each of the SOEC cores through a process fluid inlet, further through the recuperating space where it recuperates thermal energy escaping said inner hot zone, which heats up the process fluid,
providing the now heated process fluid to said SOEC stacks.

### BRIEF DESCRIPTION OF THE DRAWINGS

The invention is further illustrated by the accompanying drawings showing examples of embodiments of the invention. It is to be understood that the invention according to the claims covers many other embodiments than the ones shown in the drawings which serve the purpose of explaining the invention with specific examples.

FIG. 1 shows a plurality of SOEC stacks according to an embodiment of the invention.

FIG. 2 shows an SOEC plant comprising a number of SOEC cores in parallel process fluid connection according to an embodiment of the invention.

FIG. 3 shows an SOEC core in more detail according to an embodiment of the invention.

### POSITION NUMBERS

01. SOEC core
02. SOEC core shell
03. Thermal insulation for SOEC core shell
04. SOEC stack
05. Hot zone
06. Hot zone thermal insulation
07. Warm zone
08. Recuperating space
09. Heat exchanger
10. Heater
11. Fluid connection
12. Shut off valve
13. Process fluid connection

### DETAILED DESCRIPTION

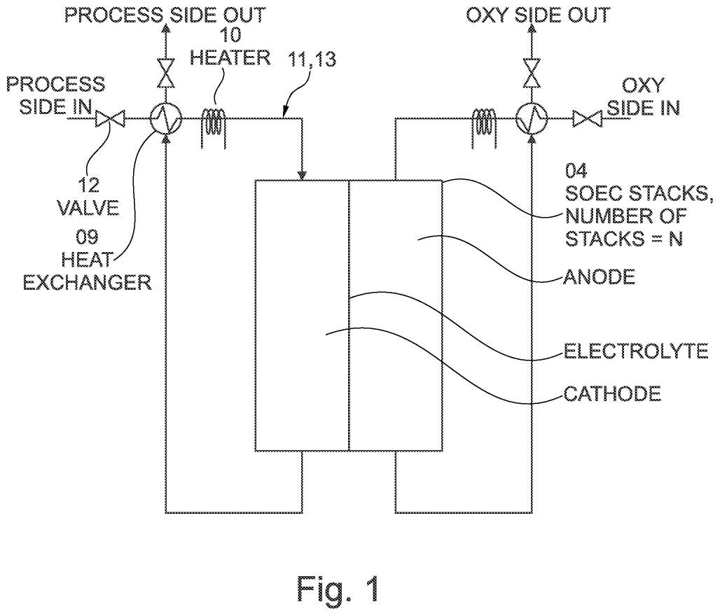

FIG. 1 shows a number of SOEC stack 04 according to an embodiment of the invention. As well known in the art, the stack comprises cells with anodes, electrolytes and cathodes. In FIG. 1, the SOEC stacks are shown in principal only i.e the exact details of the cells and stacks are not shown, but rather alle the stacks are visualized as a box. Shown are the fluid connections 11 and in particular the process fluid connections 13, which provide fluid to and from the SOEC stacks for them to be able to operate. There is a process side and an oxy side of each of the stacks. Both the process fluid and the oxy fluid need to be heated to the correct operating temperature for the SOEC stacks to operate correct. For this purpose, on both the process side and the oxy side there is a heat exchanger 09 which pre-heats the fluids by means of the heat energy in the fluids exiting the stacks. To further heat the process fluid and the oxy fluid to the correct operating temperature, there are heaters 10 located downstream the heat exchangers to heat the process fluid and oxy fluid. The whole assembly of SOEC stacks may be shut off from fluids by means of shut off valves 12 located upstream the inlet to the heat exchangers and downstream the outlets of the heat exchangers. This assembly of many SOEC stack which in FIG. 1 is shown only as a principle drawing is according the present invention called an SOEC core 01.

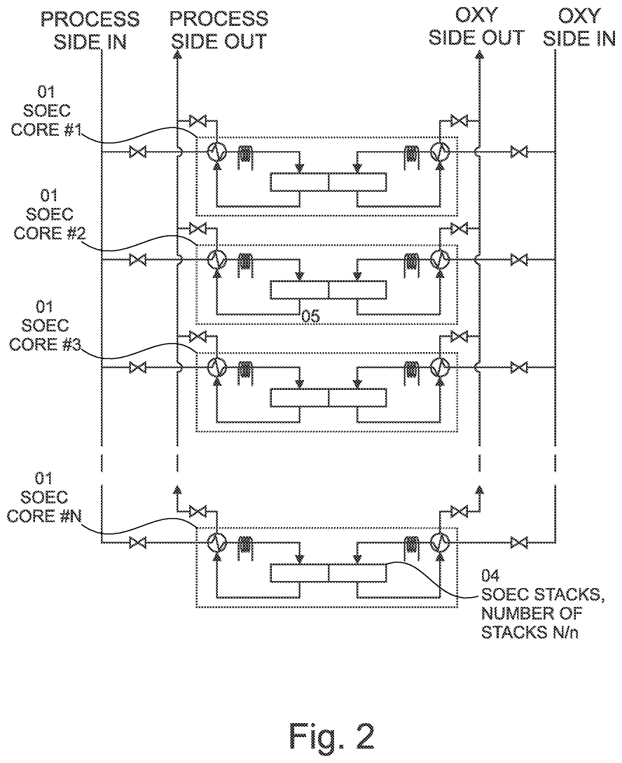

In FIG. 2, also as a principle drawing, several SOEC cores are shown in common parallel connection whereby they together form a whole SOEC plant. As can be seen common fluid lines for process fluid in, process fluid out, oxy fluid in and oxy fluid out connects all the SOEC cores. The connection runs as mentioned earlier, via shut off valves. Hence, should one of the SOEC cores need a shut down due to service or errors, it is possible to isolate that single SOEC core by shutting off all its connecting shut off valves, thereby enabling service of that specific SOEC core while still keeping the rest of the SOEC cores in operation. As already discussed, a large number of SOEC cores may be connected according to this principle, thereby providing a whole SOEC plant.

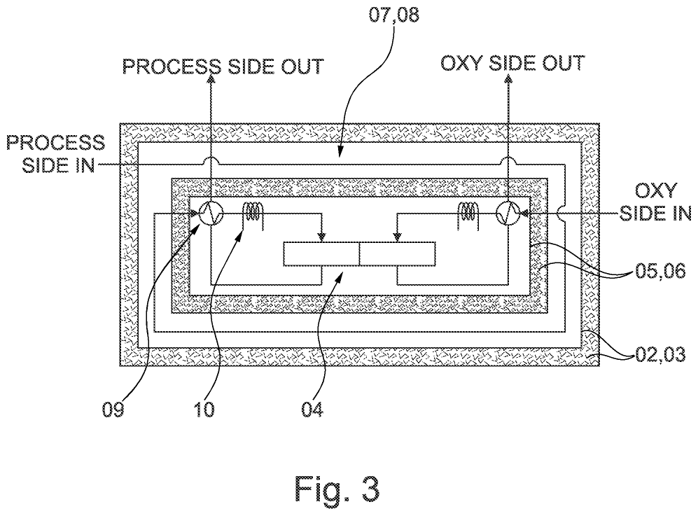

In FIG. 3, one SOEC core is shown in more detail. Two different zones are provided, an inner hot zone 05 at leats partly surrounded by hot zone thermal insulation 06; and an outer warm zone 07 (relatively colder than the hot zone) located within an SOEC core shell 02 which has a thermal insulation fo the SOEC core shell 03. Between the two zones there is a space, which allows for the flow of a fluid. This space is a rucuperating space 08, since the fluid flowing in this space recuperates heat lost from the inner hot zone, escaping through the hot zone thermal insulation. Hence, heat lost from the inner hot zone is transferred to the fluid flowing in the recuperating space. In an embodiment where this fluid is actually a fluid flowing to the SOEC stacks within the hot zone, the heat recuperated and transferred to the fluid is used as a pre-heat of the fluid before it enters the heat exchanger and heater, thus saving energy. It is further seen from FIG. 3. That both the heaters and the heat exchangers are located within the hot-zone, thus minimizing heat loss from the heat exchangers and heaters to the surroundings.

1. Solid Oxide Electrolysis Cell (SOEC) plant, comprising a plurality of SOEC stacks, said SOEC plant is divided into a plurality of SOEC cores, wherein each of said SOEC cores is adapted to be individually isolated, individually controlled and adapted to operate independently from the other of the plurality of SOEC cores.

2. SOEC plant according to claim 1, wherein each of said SOEC cores comprises a plurality of SOEC stack modules and each of said SOEC stack modules comprises one or more of said SOEC stacks.

3. SOEC plant according to claim 1, wherein said SOEC plant comprises 10 or more SOEC cores.

4. SOEC plant according to claim 1, wherein said SOEC plant comprises 25 or more SOEC cores.

5. SOEC plant according to claim 1, wherein said SOEC plant comprises 100 or more SOEC cores.

6. SOEC plant according to claim 1, wherein said plurality of SOEC cores each comprises an SOEC core shell with shell thermal insulation cladding at least the outside of said SOEC core shell and further comprising a plurality of shut off valves adapted to cut off one or more process fluids flowing to or from, or to and from said SOEC cores, wherein said plurality of shut off valves are arranged outside the SOEC core shell.

7. SOEC plant according to claim 6, wherein each of said SOEC cores has an inner hot zone at least partly surrounded with hot zone thermal insulation within the SOEC core shell and a recuperating space arranged at least partly around the outside of said hot zone thermal insulation and within the SOEC core shell to separate the hot zone from the SOEC core shell and provide a recuperating fluid path for a recuperating fluid.

8. SOEC plant according to claim 7, wherein said hot zone is located in the centre and around a centre axis of each of the SOEC core shells.

9. SOEC plant according to claim 6, wherein each of said SOEC core shells comprises at least a first shell section comprising a first end of the SOEC core shell and a second shell section comprising a second end of the SOEC core shell, said shell sections are assembled by a flange connection, one flange is arranged on the first shell section and another flange is arranged on the second shell section and the flange connection is located near the first end of the SOEC core shell.

10. SOEC plant according to claim 9, wherein each of said SOEC cores further comprises one or more heat exchangers, one or more heaters, a plurality of fluid connections, and a plurality of electrical connections to the plurality of SOEC stack modules and wherein said one or more heat exchangers, one or more heaters, plurality of fluid connections, plurality of electrical connections and the plurality SOEC stacks are fixed to said first shell section.

11. SOEC plant according to claim 10, wherein said one or more heat exchangers and one or more heaters are located within said hot zone.

12. SOEC plant according to claim 10, wherein at least a larger part of said plurality of electrical connections are located outside said hot zone.

13. SOEC plant according to claim 10, further comprising a plurality of lead-through holes for said plurality of fluid connections, and plurality of electrical connections, wherein said lead-through holes are located in said first shell section.

14. SOEC plant according to claim 10, wherein said plurality of shut off valves are connected to one or more of said plurality of fluid connections and are adapted to cut off the fluid flowing in said fluid connections.

15. SOEC plant according to claim 10, further comprising a plurality of circuit breakers adapted to cut off power running in said electrical connections.

16. SOEC plant according to claim 7, wherein the components and materials located within said hot zone are adapted to withstand temperatures up to at least 825° C.

17. SOEC plant according to claim 7, wherein the components and materials located within said hot zone are adapted to withstand temperatures up to 1000° C.

18. SOEC plant according to claim 10, wherein at least one of the plurality of fluid connections is a process fluid connection adapted to provide process fluid connection from a process fluid inlet arranged in each of the SOEC core shells, further to the recuperating space within the SOEC core shell and further to said plurality of SOEC stack modules.

19. SOEC plant according to claim 6, wherein said plurality of SOEC stack modules are arranged at least partly in a circular arrangement around a central axis of said SOEC core shell.

20. SOEC plant according to claim 2, wherein each of said SOEC cores comprises between 2 and 50 SOEC stack modules, preferably between 3 and 20 SOEC stack modules, preferably between 5 and 9 SOEC stack modules, preferably 6 stack modules.

21. Method of operating a Solid Oxide Electrolysis Cell (SOEC) plant, comprising a plurality of SOEC stacks, said SOEC plant is divided into a plurality of SOEC cores comprising an SOEC core shell, said SOEC cores has an inner hot zone at least partly surrounded with hot zone thermal insulation within the SOEC core shell and a recuperating space arranged at least partly around the outside of said hot zone thermal insulation and within the SOEC core shell to separate the hot zone from the SOEC core shell and provide a recuperating fluid path for a recuperating fluid the method comprises the steps of:
providing electrical power to said plurality of SOEC stacks,
providing a process fluid to each of the SOEC cores through a process fluid inlet, further through the recuperating space where it recuperates thermal energy escaping said inner hot zone, which heats up the process fluid,
providing the heated process fluid to said SOEC stacks.
